(19) United States
(12) Patent Application Publication
(10) Pub. No.: US 2015/0246432 A1
(43) Pub. Date: Sep. 3, 2015

(54) LOCKING PLIERS WITH CUSTOMIZABLE JAWS

(71) Applicant: Irwin Industrial Tool Company, Huntersville, NC (US)

(72) Inventors: William Craig, Indian Trail, NC (US); Douglas Johnson, Belmont, NC (US); James Joseph Uttley, Huntersville, NC (US)

(21) Appl. No.: 14/630,879

(22) Filed: Feb. 25, 2015

Related U.S. Application Data
(60) Provisional application No. 61/946,218, filed on Feb. 28, 2014.

(51) Int. Cl. B25B 7/02; B25B 7/12

(52) U.S. Cl. CPC B25B 7/02; B25B 7/123

(57) ABSTRACT

A locking pliers has a first jaw and a second jaw movable with respect to one another. A locking mechanism locks the first jaw and the second jaw in position relative to one another. At least one of the jaws is provided with an attachment structure that allows a variety of work holders to be removably or permanently attached to the jaw. At least one of the jaws may be provided with a receiving surface that allows a surface of a variety of different types of work holders to be attached to the jaw such as by welding.

This application claims benefit of priority under 35 U.S.C. §119(e) to the filing date of U.S. Provisional Application No. 61/946,218, as filed on Feb. 28, 2014, which is incorporated herein by reference in its entirety.

### BACKGROUND

Locking pliers typically comprise a fixed assembly having a fixed handle at one end and a fixed jaw at the other end. A movable handle is pivotably connected at one end to a movable jaw. A movable jaw is pivotably connected to the fixed assembly. A locking mechanism locks the movable jaw relative to the fixed jaw. Typically, one or more links are pivotably connected between the movable handle and the fixed handle to create an over center locking mechanism that locks the jaws relative to one another such that a force applied to the jaws cannot open the jaws. One end of one of the links in the over center locking mechanism may be in contact with the end of adjustment screw where rotation of the adjustment screw alters the geometry of the linkage to define a space between the jaws in the locked position such that articles of different sizes may be gripped with varying amounts of pressure. The jaws may only be opened by releasing the over center locking mechanism. In some embodiments, a release lever may be provided such that a user can depress the distal end of lever to unlock the linkage. A spring may be used that applies a bias force to the fixed and movable assemblies which tends to move the jaws away from one another when the linkage is unlocked.

### SUMMARY

In some embodiments, a locking pliers comprises a first jaw and a second jaw movable with respect to one another. A locking mechanism locks the first jaw and the second jaw in position relative to one another. A first work holder is removably attached to the first jaw.

The first jaw may comprise a first attachment structure and the first work holder may comprise a second attachment structure that is releasably engageable with the first attachment structure. The first attachment structure may comprise a rail. The second attachment structure may slide onto the rail from the end of the jaws. The rail may comprise a pair of extending flanges that extend along the first jaw. The second attachment structure may comprise a channel that fits over the rail. A fixing mechanism may fix the first attachment structure to the second attachment structure. The fixing mechanism may comprise a screw. The fixing mechanism may be inserted through aligned holes in the first jaw and the work holder. The fixing mechanism may comprise a ball and detent. The fixing mechanism may comprise an eccentric cam that is rotated into engagement with the first jaw. The fixing mechanism may comprise a friction fit. The first work holder comprises at least one of a flat plate, a standard jaw, a long nose pliers jaw, a wrench jaw, a large jaw, a locking panel clamp, a locking chain, a welding clamp, and a wide opening clamp. A second work holder may be removably attached to the second jaw. A first arm may be connected to the first jaw and a second arm may be connected to the second jaw and a light may be removably attached to an end of one of the first arm and the second arm.

In some embodiments locking pliers comprises a first jaw and a second jaw movable with respect to the first jaw. A locking mechanism locks the first jaw and the second jaw in position relative to one another. The first jaw comprises a first attachment structure. A first work holder including a second attachment structure that is releasably engageable with the first attachment structure. A fixing mechanism permanently secures the first work holder to the first jaw.

The work holder may be connected to the jaw at a one of a welded joint and a brazed joint. The work holder may be connected to the jaw by a mechanical deformation of the work holder.

In some embodiments, a locking pliers comprises a first jaw and a second jaw movable with respect to one another. A locking mechanism locks the first jaw and the second jaw in position relative to one another. A first attachment structure is provided on the first jaw. A plurality of different types of work holders each comprising a second attachment structure where the second attachment structure is removably attachable to the first attachment structure.

### BRIEF DESCRIPTION OF THE DRAWINGS

FIG. 1 is a side view of an embodiment of a locking pliers of the invention in a locked position.

FIG. 2 is a side view of the locking pliers of FIG. 1 in an open position.

FIG. 3 is a perspective view of another embodiment of a locking pliers of the invention.

FIG. 4 is an end view of the locking pliers of FIG. 1.

FIG. 5 is a side view of another embodiment of a locking pliers of the invention.

FIG. 6 is a perspective view of another embodiment of a locking pliers of the invention.

FIGS. 7-12 are perspective views of alternate embodiments of work holders usable with the locking pliers of the invention.

FIGS. 13-20 are partial section views showing alternate embodiments of the attachment mechanism between the work holders and a pliers.

FIG. 21 is a perspective view showing an alternate embodiment of an attachment mechanism between a work holder and a pliers.

FIGS. 22-28 are side views showing alternate embodiments of work holders usable with the pliers of the invention.

FIG. 29 is a side view showing an embodiment of a work holder attached to an embodiment of a pliers.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

Relative terms such as “below” or “above” or “upper” or “lower” or “horizontal” or “vertical” or “top” or “bottom” may be used herein to describe a relationship of one element, component or region to another element, component or region as illustrated in the figures. It will be understood that these terms are intended to encompass different orientations of the device in addition to the orientation depicted in the figures.

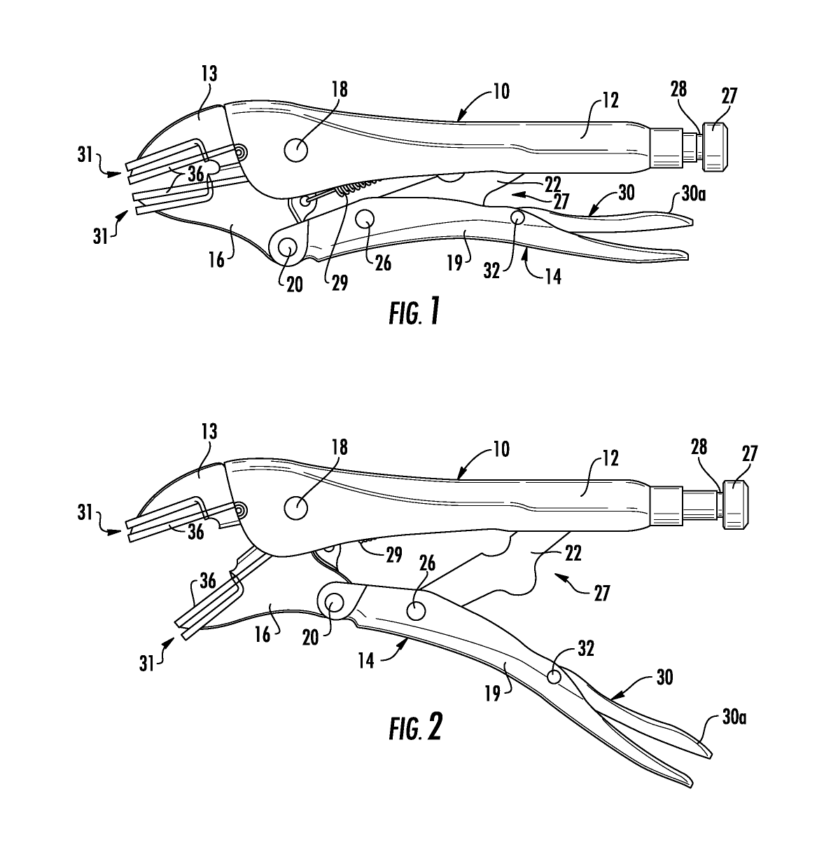

Referring to the figures various embodiments of a locking pliers are shown. The basic structure and operation of the locking pliers will be described that is generally applicable to all of the disclosed embodiments. It is to be understood that locking pliers may have a variety of constructions and the locking mechanisms and releases may vary. However, locking pliers are generally defined by the ability to lock the jaws relative to one another at a desired spacing/pressure using a locking mechanism operatively connected between a fixed jaw and a movable jaw, typically via a fixed assembly and a movable assembly, where the jaws may only be unlocked by manipulation of the locking mechanism. In the illustrated embodiments, the locking pliers comprise a fixed assembly 10 having a fixed handle 12 at one end and a fixed jaw 13 at the other end. A movable assembly 14 comprises a movable handle 19 that is pivotably connected at one end to a movable jaw 16 by pivot pin 20. A pivot pin 18 connects the movable jaw 16 to the fixed assembly 10. A locking mechanism 27 locks the movable jaw 16 relative to the fixed jaw 13. The locking mechanism 27 comprises one or more links 22 that defines a linkage that is operatively coupled between the movable assembly 14 and the fixed assembly 10. In one embodiment the linkage comprises a link 22 that is pivoted to the movable handle 19 at a pivot 26. The opposite end of link 22 is in sliding and pivoting contact with the end of adjustment screw 28. In some embodiments, a release lever 30 may be provided that has a first end that may contact link 22 and a second end 30a that is accessible to the user. The release lever may be pivotably connected to the movable handle at pivot 32 such that a user can depress the distal end 30a of lever 30 to move the opposite end of the lever against the link 22 to unlock the linkage thereby unlocking the jaws 13 and 16. A biasing spring 29 extends between the movable jaw 16 and the fixed handle 12 that applies a bias force which tends to move the jaws 13 and 16 away from one another to the position of FIG. 2 when the locking mechanism 27 is unlocked.

When the jaws 13 and 16 are in the open position of FIG. 2, the pivot points, 18, 20, 26 and the point of contact between the end of link 22 with the end of the adjusting screw 14 are arranged as a polygon. When the jaws are in the locked position, the pivots 20, 26 and the point of contact between link 22 and screw 14 are substantially in a straight line with the pin 26 in an over-center position where it is positioned slightly inside (toward fixed assembly 10) of the line between pivot 20 and the point of contact between link 22 and the screw 14. The jaws 13 and 16 cannot be pried apart from the locked position by application of a force to the jaws 13 and 16 because separation of the jaws is prevented by the over-center condition of the pin 26. However, the jaws 13 and 16 may be unlocked and separated by applying a force to the movable handle 19 in a direction which moves the movable handle 19 away from the fixed handle 12 or by manipulating release lever 30. A configuration of the pivots which places the mechanism in a locked position when the jaws are closed or clamping a workpiece can be considered an over-center mechanism when force applied directly to the jaws is not effective in separating the jaws and the jaws can only be opened by forces acting on the locking mechanism. Other locking mechanisms are known and may also be used to lock the jaws relative to one another. For example, the locking mechanism may comprise a compound linkage, a self-adjusting locking mechanism or other type of locking mechanism.

The end of the fixed handle 12, remote from the jaw 13, comprises a threaded aperture through which threaded adjustment screw 28 is threadably engaged. The end of the link 22 is slidably and pivotably engaged with the end of the adjusting screw 28. Turning the adjusting screw 28 changes the distance between the end of the link 22 and the pivot point 18 of the movable jaw 16 to change the geometry of the linkage, whereby the jaws 13 and 16 may be adjusted to vary the spacing between the jaws in the locked position to grip objects of different dimensions with varying force.

The customizable jaw structure disclosed herein may be used in other types of locking pliers such as disclosed in U.S. Pat. No. 8,056,451, titled “Locking Pliers” and issued to Chervenak et al. on Nov. 15, 2011 which is incorporated by reference herein in its entirety; U.S. Pat. No. 8,122,792, titled “Self-Adjusting Locking Pliers” and issued to Engvall et al. on Feb. 28, 2012 which is incorporated by reference herein in its entirety; U.S. Pat. No. 8,776,646, titled “Locking Pliers” and issued to Chervenak et al. on Jul., 15, 2014 which is incorporated by reference herein in its entirety; and U.S. Pat. No. 6,626,070, titled “Compound Toggle Link Retention Mechanism” and issued to Peperkorn et al. on Sep. 30, 2003 which is incorporated by reference herein in its entirety. The customizable jaws of the invention may be used in any locking pliers and may also be used in non-locking pliers if desired.

The construction of the locking pliers may take the form of a large jaw locking clamp as shown in FIG. 6. The clamp operates in the same manner as the locking pliers described above; however, the jaws 13 and 16 are configured as large capacity clamping jaws. Typically in a clamp as arranged in FIG. 6 the jaws are configured to perform a clamping function as opposed to the wrenching jaws of the embodiment of FIG. 1. The locking pliers may have a variety of configurations in addition to those shown herein.

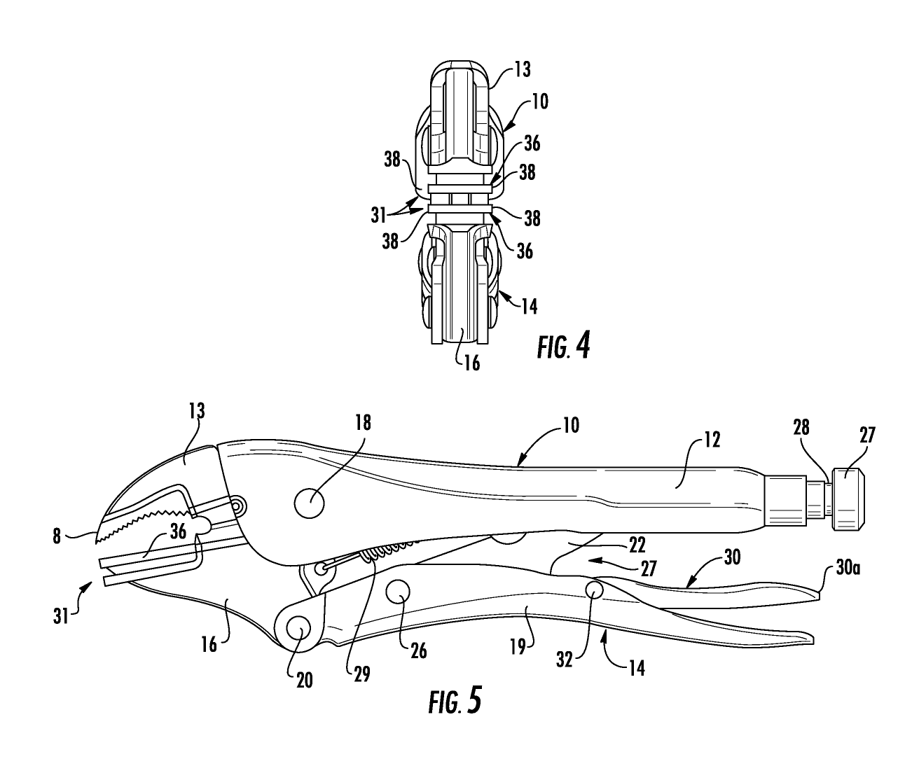

In one embodiment, one or both of the jaws 13 and 16 are provided with customizable jaw faces/work holders 30 such that the locking pliers may be customized with different jaw faces/work holders. Different applications and uses of locking pliers may require different jaw faces/work holders 30. Locking pliers are used by many tradesmen such as welders, HVAC installers, plumbers, auto workers and the like as work holders, clamps, wrenches to perform a variety of holding, clamping, wrenching and other functions. The customizable jaw faces/work holders 30 may comprise a wide variety of structures including, but not limited to, those described herein. The term “work holder” will be used to refer to any type of jaw face, work holder, clamping device, tool or the like that may be attached to the locking pliers jaws as described herein. In some embodiments one of the jaws 13, 16 may be provided with the attachment mechanism 31 for holding a customizable work holder 30 and the other jaw may comprise a standard jaw 8 as shown in FIG. 5.

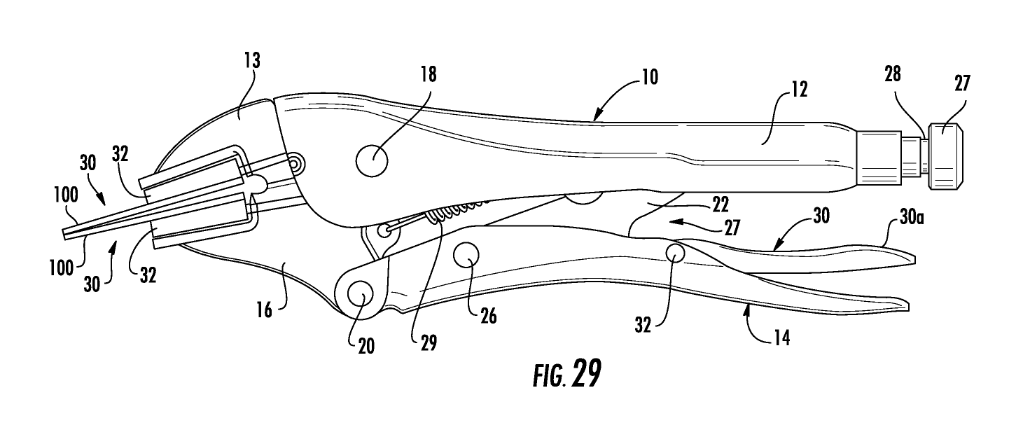

In one embodiment the jaws 13 and 16, or one of the jaws 13 and 16, are formed with a first matting attachment structure 31 that engages a second mating attachment structure 32 formed on the work holders 30. For example, the jaws 13, 16 may be provided with a male or female member that engages a mating female or male member on the work holders 30. In one embodiment the first attachment structure 31 comprises a rail 36 where the second attachment structure 32 may be slid onto the rail from the end of the jaws. The rail 36 may comprise a pair of extending flanges 38 that create a generally T-shaped rail. The rails 36 extend along the length of the jaws 13, 16. The second attachment structure 32 on the work holder 30 comprises a C-shaped channel 44 that fits over the rail 36 such that the channel 44 may slide onto the rail 36. The channel 44 has a pair of inwardly facing flanges 45 that fit over the flanges 38 such that the channel 44 may slide onto the rail 36 but once fully inserted on the rail the engagement of the inwardly extending flanges 45 with outwardly extending flanges 38 maintains the channel 44 on the rail 36 as shown in FIG. 29.

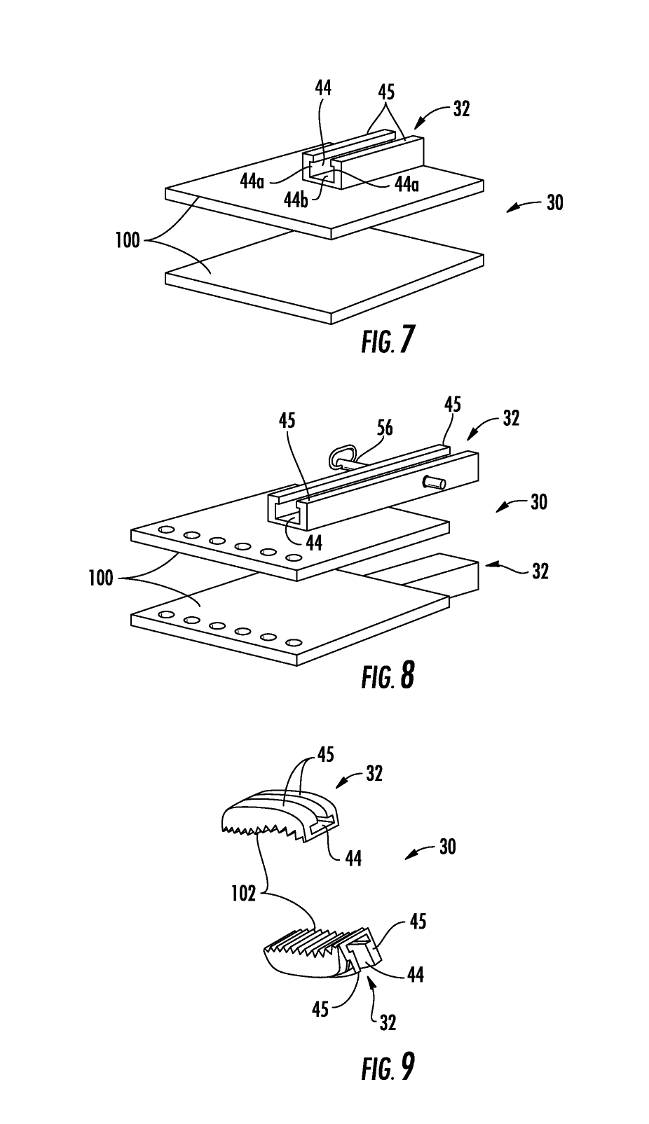

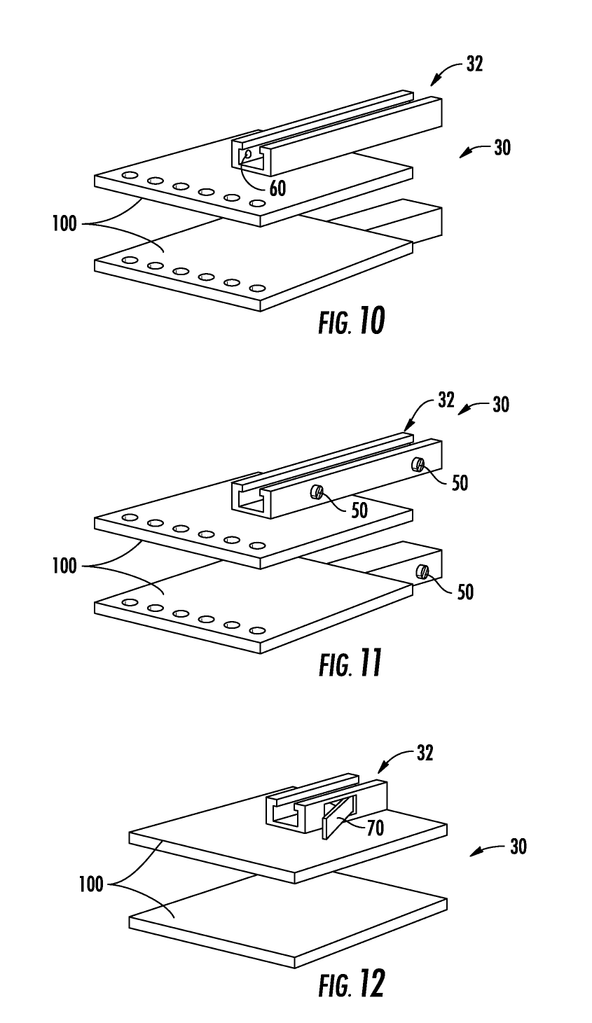

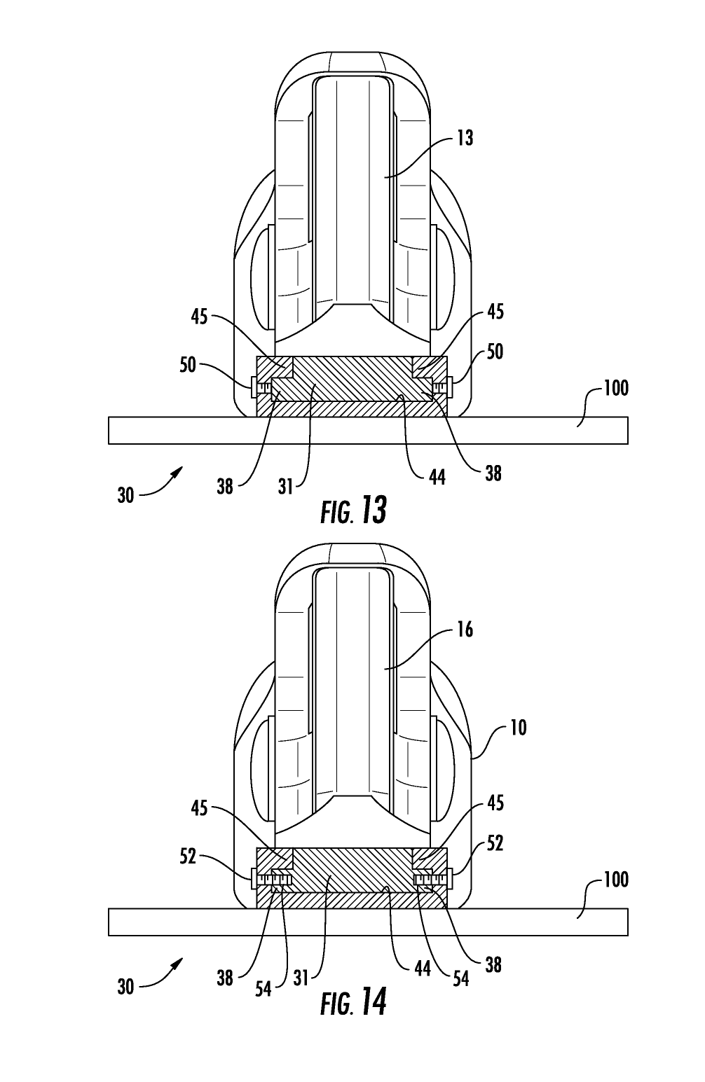

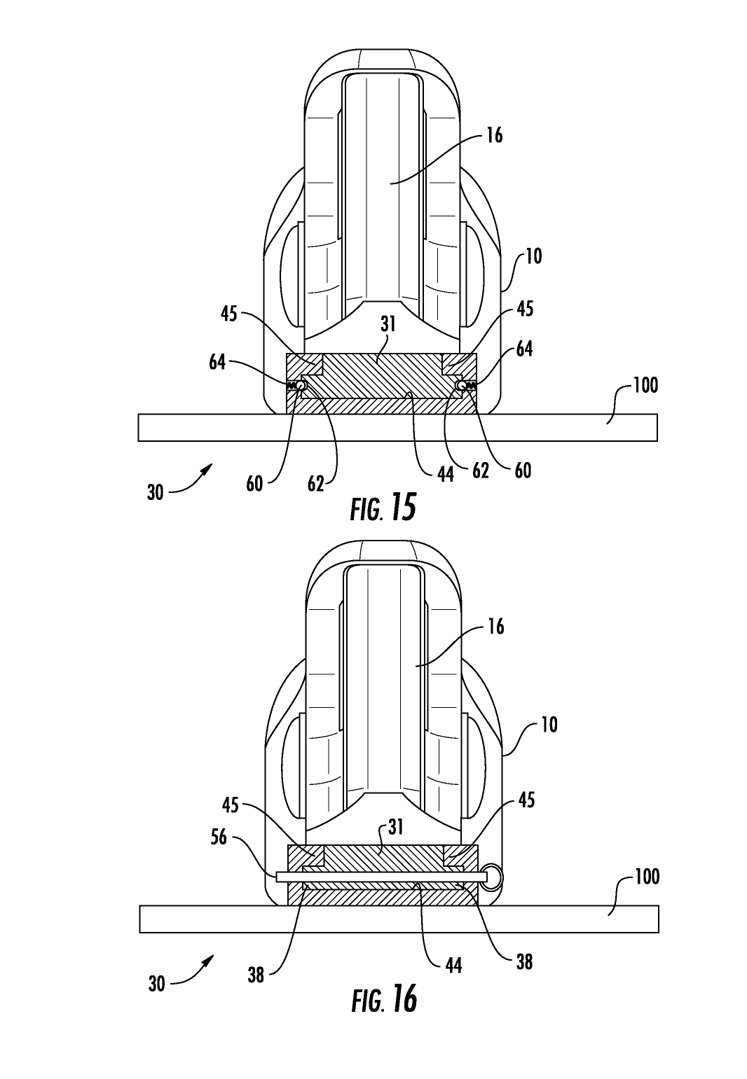

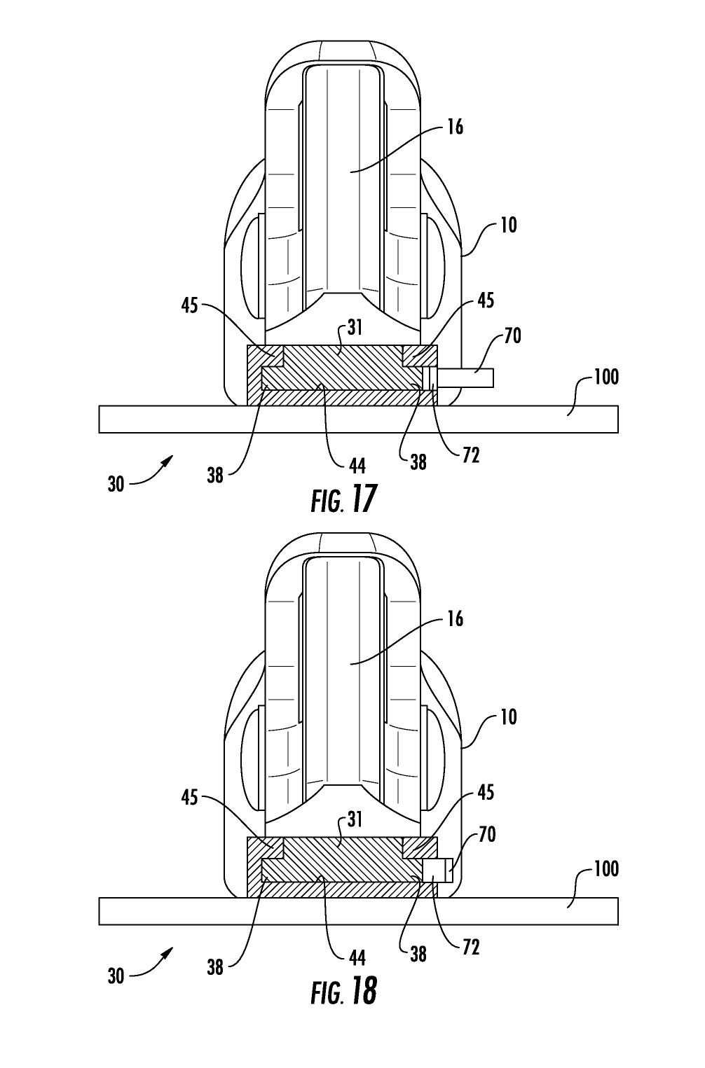

A fixing mechanism may be used fix the work holder 30 on the rail 36. In one embodiment the fixing mechanism is detachable such that the work holder 30 may be removed from the pliers and a second different work holder 30 may be attached to the pliers. In this manner an end user may modify a single pliers to perform a number of different functions based on the configuration of the work holders 30. In one embodiment, the fixing mechanism may comprise a set screw or a plurality of set screws 50 that engage a surface of the jaws to releasably fix the work holder 30 to the jaw as shown in FIGS. 11 and 13. The set screws 50 may be tightened against the sides of the jaws 13, 16 and may be provided on both sides of the channel 44. In another embodiment the fixing mechanism may comprise screws 52 that engage threaded holes 54 in the jaws 13 and 16 as shown in FIG. 14 rather than simply engaging the wall of the jaws. The screws 52 may be tightened into the threaded holes 54 and may be provided on both sides of the channel 44. In one embodiment, the fixing mechanism may comprise a pin such as a clevis pin, cotter pin, detent pin or similar device 56 that is inserted through aligned holes in the jaws 13, 16 and work holder 30 as shown in FIGS. 8 and 16. The pin 56 may be replaced by a fastener such as a bolt that is inserted through the aligned holes in the jaws and work holder and secured by a nut. In another embodiment the fixing mechanism may comprise a ball and detent arrangement where a spring biased ball 60 on one of the jaws 13, 16 or the work holder 30 engages a detent 62 on the other one of the jaws 13, 16 or work holder 30 as shown in FIGS. 10 and 15. The ball 60 is biased by spring 64 to releasably engage detent 62 in a snap-fit quick-release connection. Referring to FIGS. 12, 17 and 18, another embodiment the fixing mechanism may comprise a movable lever 70 that moves an engagement structure 72 into engagement with the jaws when the lever 70 is moved from an unlocked position (FIG. 17) to a locked position (FIG. 18). The engagement structure 72 may comprise an end of the lever 70 that operatively engages the jaws where the end of the lever may comprise an eccentric cam that is rotated into engagement with the jaws when the lever 70 is rotated. In these and other embodiments the components may be reversed.

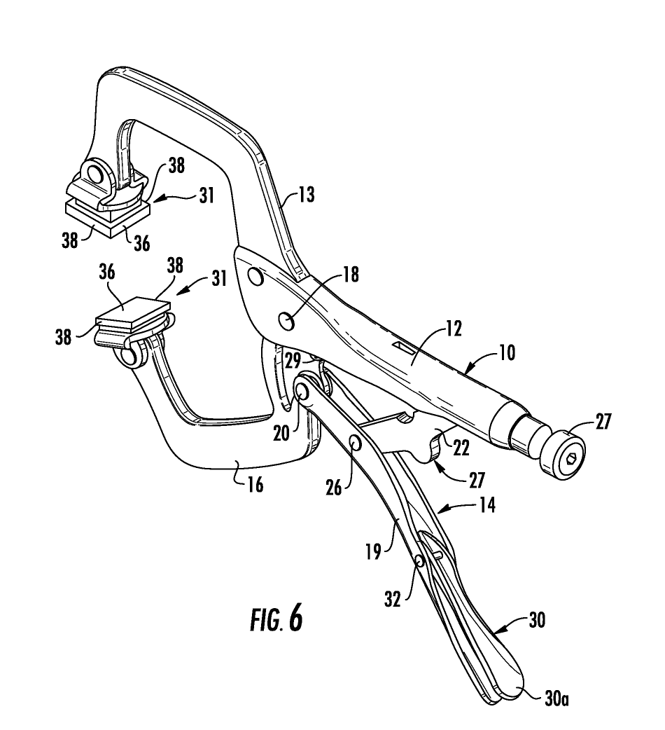

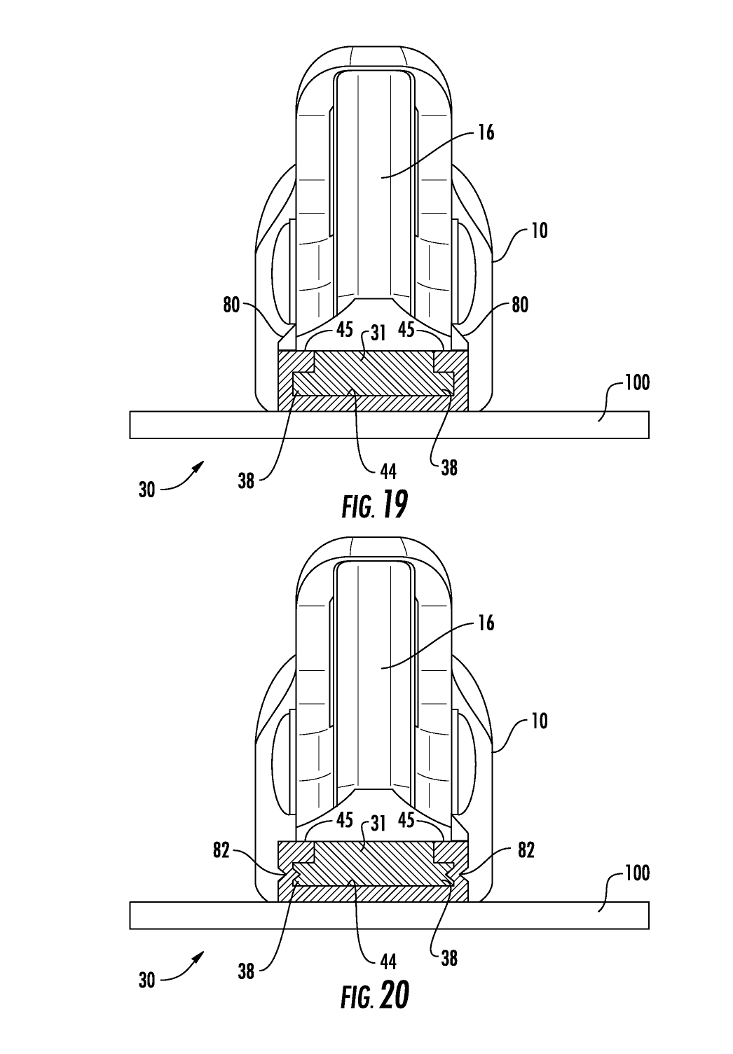

In addition to the releasable fixing mechanisms described above the work holders may be permanently secured to the jaws using a permanent fixing mechanism such that the work holder is not removable or not easily removable once attached to the jaws. Referring to FIG. 19, the fixing mechanism may comprise a welded or braised joint 80 that attaches the work holder 30 to the jaws. Referring to FIG. 20 fixing mechanism may comprise a mechanical deformation 82 of the work holder 30 and jaws 13, 16 to mechanically lock the work holders 30 to the jaws. In other embodiments the fixing mechanism may comprise a tight friction fit between the channel 44 and the rail 36 as shown in FIG. 7. The friction fit may be loose enough to allow the work holder 30 to be easily removed. In other embodiment the friction fit may be relatively tight such that the work holders may only be removed using tools such as a hammer. To create a tight friction fit both the rails 36 and the side walls 44a and/or bottom wall 44b and flanges 45 of channel 44 may be angled toward one another from the front of the attachment structure 32 toward the back of the attachment structure such that they form a shallow V-shape. The channel 44 may then be forced onto the rail 36 such as by using a hammer to create a wedging action that tightly holds the work holders 30 to the jaws 13 and 16.

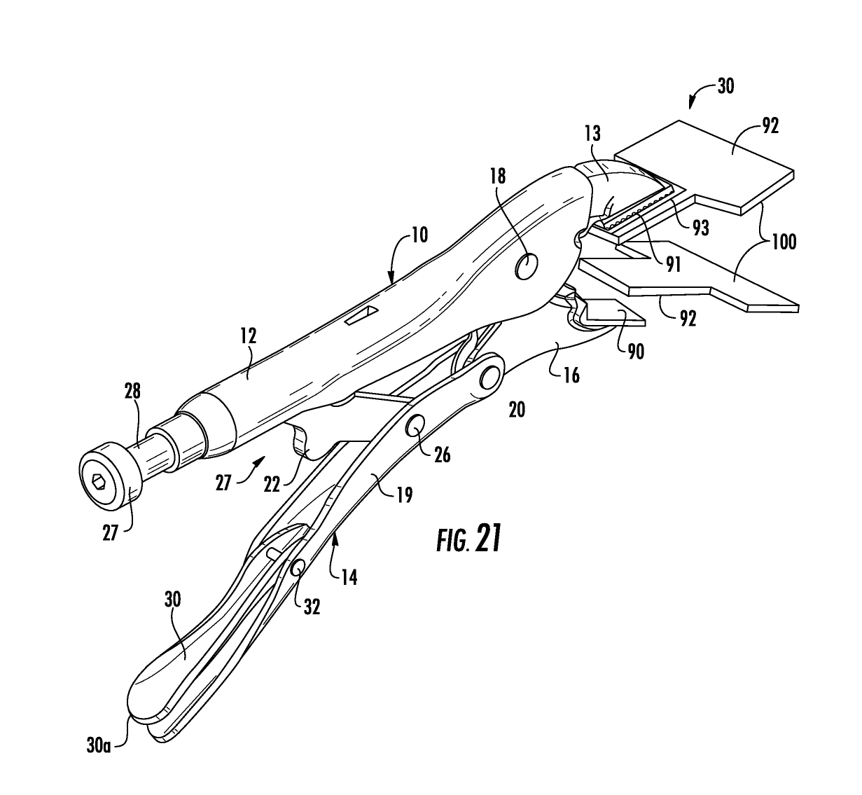

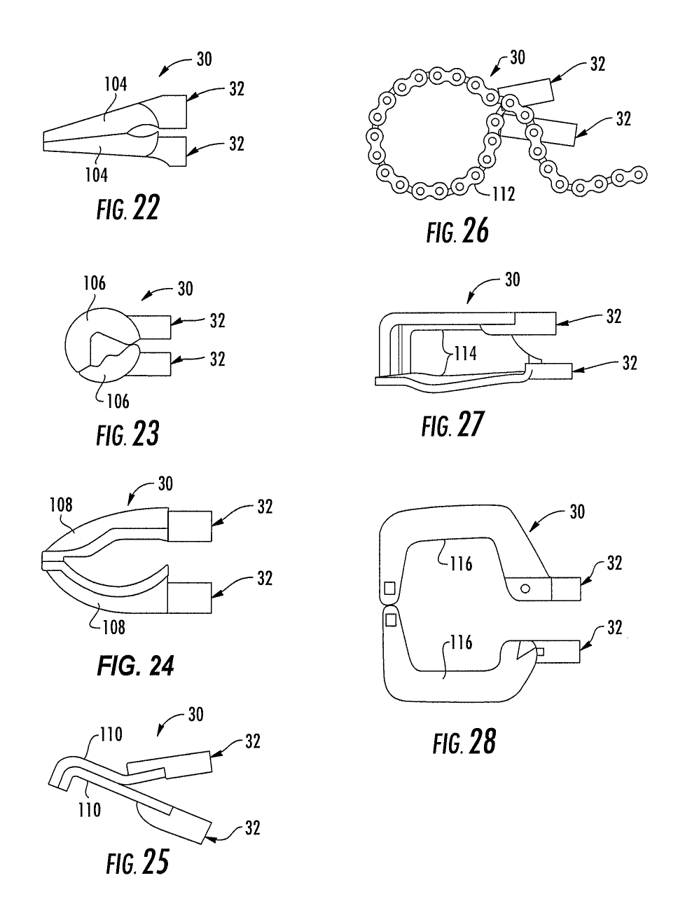

The work holders 30 may be provided in a wide variety of shapes, sizes and configurations depending upon the function of the tool. FIGS. 7 and 8 show the work holders as relatively flat plates 100 that may be advantageously used as a sheet metal tool for bending, forming and crimping sheet metal. The flat plates 100 may be made in a wide variety of shapes and sizes. FIG. 9 shows the work holders 30 as standard jaw faces 102 that may be used for a wide variety of applications and may comprise curved or straight jaws having a variety of configurations. FIG. 22 shows the work holders 30 as long nose pliers jaws 104. FIG. 23 shows the work holders as wrench jaws 106. FIG. 24 shows the work holders 30 as large jaws 108. FIG. 25 shows the work holders 30 as locking panel clamps 110 suitable for clamping and aligning auto panels. FIG. 26 shows the work holder 30 as a locking chain clamp 112. FIG. 27 shows the work holders 30 as a welding clamp 114. FIG. 28 shows the work holders 30 as a wide opening clamp 116. Other types and styles of work holders in addition to those disclosed and shown in the drawings may also be provided.

Referring to FIG. 21 in one embodiment the jaws 13 and 16 are formed with receiving surfaces having no mating attachment structure. The receiving surfaces 90 may be used to support and abut mating surfaces 92 on the work holders 30 where the work holders 30 are attached to the receiving surfaces 90 by welds 91 or other separate fixing mechanism. In one embodiment the mating surfaces are flat smooth surfaces to facilitate the welds 91 between the jaws 13, 16 and the work holders 30. The work holders 30 may comprise any type or style of work holder. The pliers may be made and sold with the flat receiving surfaces 90 on the jaws 13, 16 such that an end user may attach, such as by welding, any desired work holder 30. In some embodiments the work holder surfaces 92 may be formed with a perimeter 93 that receives the receiving surfaces 90 to properly align the work holders 30 with the jaws 13 and 16 prior to welding or brazing the permanent connection. Unlike in the prior embodiments the perimeter 93 does not hold the work holder 30 on the jaws and is provided only for alignment purposes. The perimeter 93 may comprise a raised lip, recessed area, visual indicia such as a printed or stamped line or other marking

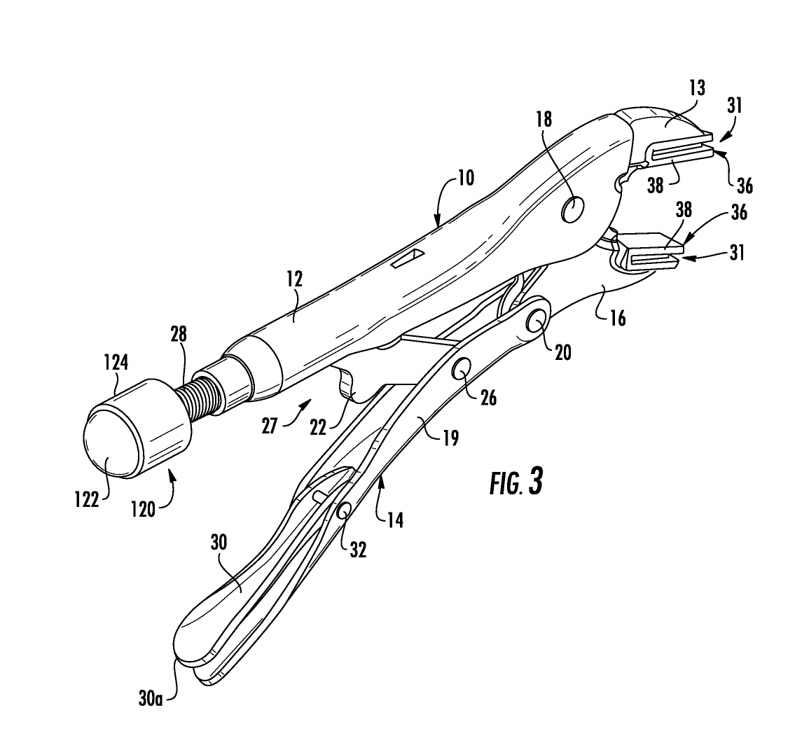

In other embodiments the locking pliers may be provided with a light 120 to enhance visibility as shown in FIG. 3. In one embodiment the light may comprise a LED lamp 122 powered by a battery although other light sources may be used. The light 120 may be mounted to the end of one of handles 12 and 19. In the illustrated embodiment the light 120 is mounted to the knurled knob 27 typically found at the end of adjustment screw 28. By mounting the light 120 at the end of one of the handles, the jaws 13, 16 may be clamped on a support structure and the light 120 may be directed outwardly. In this manner the locking pliers may be used as a light holder that is attachable to a wide variety of structures.

In one embodiment the light 120 may comprise a sleeve 124 that may be releasably mounted to the pliers such that the light may be removed. In one embodiment a magnet in the sleeve 124 may releasably attach the light to the pliers. In another embodiment, the sleeve 124 may comprise an elastomeric material that may be deformed to fit over the end of the handles or the knob 27 as shown. The sleeve 124 may be resiliently deformed to secure the light to the knob 27. In other embodiments the sleeve 124 may comprise a mechanical attachment mechanism such as an adjustable band, set screws, internal screw threads that mate with external screw threads formed on the knob 27, a clamp or other releasable structure. The light 120 may also be permanently attached to the pliers such as by welding or the like.

Although specific embodiments have been shown and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

1. A locking pliers comprising:
a first jaw and a second jaw movable with respect to one another;
a locking mechanism for locking the first jaw and the second jaw in position relative to one another;
a first work holder removably attached to the first jaw.

2. The locking pliers of claim 1 wherein the first jaw comprises a first attachment structure and the first work holder comprises a second attachment structure that is releasably engageable with the first attachment structure.

3. The locking pliers of claim 2 wherein the first attachment structure comprises a rail.

4. The locking pliers of claim 3 wherein the second attachment structure slides onto the rail from the end of the jaws.

5. The locking pliers of claim 3 wherein the rail comprises a pair of extending flanges that extend along the first jaw.

6. The locking pliers of claim 2 wherein the second attachment structure comprises a channel.

7. The locking pliers of claim 3 wherein the second attachment structure comprises a channel that fits over the rail such that the channel may slide onto the rail.

8. The locking pliers of claim 2 further comprising a fixing mechanism to fix the first work holder to the first jaw.

9. The locking pliers of claim 8 wherein the fixing mechanism comprises a screw.

10. The locking pliers of claim 8 wherein the fixing mechanism is inserted through aligned holes in the first jaw and the first work holder.

11. The locking pliers of claim 8 wherein the fixing mechanism comprises a ball and detent.

12. The locking pliers of claim 8 wherein the fixing mechanism comprises an eccentric cam.

13. The locking pliers of claim 8 wherein the fixing mechanism comprises a friction fit.

14. The locking pliers of claim 1 wherein the first work holder comprises at least one of a flat plate, a standard jaw, a long nose pliers jaw, a wrench jaw, a large jaw, a locking panel clamp, a locking chain, a welding clamp, and a wide opening clamp.

15. The locking pliers of claim 1 comprising a second work holder removably attached to the second jaw.

16. The locking pliers of claim 1 comprising a first arm connected to the first jaw and a second arm connected to the second jaw and a light removably attached to an end of one of the first arm and the second arm.

17. A locking pliers comprising:
a first jaw and a second jaw movable with respect to the first jaw;
a locking mechanism for locking the first jaw and the second jaw in position relative to one another;
the first jaw comprising a first attachment structure;
a first work holder, the first work holder comprising a second attachment structure that is releasably engageable with the first attachment structure;
a fixing mechanism for permanently securing the first work holder to the first jaw..

18. The locking pliers of claim 16 wherein the work holder is connected to the jaw at a one of a welded joint and a brazed joint.

19. The locking pliers of claim 16 wherein the work holder is connected to the jaw by a mechanical deformation of the work holder.

20. A locking pliers comprising:
a first jaw and a second jaw movable with respect to one another;
a locking mechanism for locking the first jaw and the second jaw in position relative to one another;
a first attachment structure on the first jaw;
a plurality of different types of work holders each comprising a second attachment structure where the second attachment structure is removably attachable to the first attachment structure.
